(19) United States
(12) Patent Application Publication
(10) Pub. No.: US 2020/0004487 A1
(43) Pub. Date: Jan. 2, 2020

(54) OBJECT MOVING PROGRAM

(71) Applicant: Roland DG Corporation, Hamamatsu-shi, Shizuoka (JP)

(72) Inventors: Masaki HANAJIMA, Hamamatsu-shi (JP); Takeshi TSUJI, Hamamatsu-shi (JP); Takaaki KOKUBO, Hamamatsu-shi (JP); Takayuki KAWAI, Hamamatsu-shi (JP)

(21) Appl. No.: 16/485,208

(22) PCT Filed: Feb. 19, 2018
(86) PCT No.: PCT/JP2018/005723

§ 371 Date: Aug. 12, 2019

(30) Foreign Application Priority Data
Feb. 21, 2017 (JP) 2017-029597

(51) Int. Cl. G06F 3/14; G06F 3/0485; G06F 3/0488; G06F 3/041; G06F 3/0486

(52) U.S. Cl. CPC G06F 3/14; G06F 3/0485; G06F 3/0486; G06F 3/041661; G06F 3/04886

(57) ABSTRACT

A non-transitory computer-readable medium including a program for moving objects makes it possible, even when movement objects are moved over other objects, to see these other objects. All first movement objects and second movement objects move in a horizontal direction in response to a horizontal swipe operation, but fixed objects are displayed when the movement objects overlap the fixed objects because the fixed objects are arranged in a layer that is higher than the one that the first movement objects and the second movement objects are in. All the second movement objects located on a vertical-direction side of a vertical swipe operation start point move in a vertical direction in response to a vertical swipe operation, but the first movement objects are displayed when the second movement objects overlap the first movement objects because the first movement objects are arranged in a layer that is higher than the one that the second movement objects are in.

### BACKGROUND OF THE INVENTION

### 1. Field of the Invention

The present invention relates to object moving programs for moving objects displayed on a display screen.

### 2. Description of the Related Art

Recently, mobile terminals such as notebook personal computers, smartphones, tablet terminals, and PDAs are gaining in popularity. Touch panels layered on the display surface of their displays are used as a pointing device that allows a user to input information to these mobile terminals. In these mobile terminals, multiple icons appear on the display. The mobile terminal moves the icons on the display when a user touches the touch panel, touches and presses down on it, and swipes across it. In particular, in the mobile terminals described in JP-A-2013-73513, the icons in the same row as the designated icon move together in the horizontal direction when a user performs a flick or swipe operation in a horizontal direction with his/her fingertip using one of the multiple icons arranged in an array.

When one or more fixed icons are presented on the display other than the moving train of icons, one or more moving icons could overlap the fixed icon(s). The moving icons hide the fixed icon(s), preventing the user from seeing the fixed icons when the train of icons is moving.

### SUMMARY OF THE INVENTION

Preferred embodiments of the present invention provide the possibility, even when movement objects such as icons are moved over other objects, to see these other objects.

A preferred embodiment of the present invention provides a non-transitory computer-readable medium including a program causing a computer to function as a first direction operation detector to detect an operation in a first direction in a first state in which a plurality of first movement objects and a plurality of second movement objects are aligned in the first direction on a first-direction side of a fixed object that is fixed in a display screen and the plurality of second movement objects are aligned on a second-direction side of each of the plurality of first movement objects, the second-direction side being perpendicular in the first direction, a second direction operation detector to detect an operation in the second direction in the first state, a first direction movement controller to move, in a case that the first direction operation detector detects an operation in the first direction, the plurality of first movement objects and the plurality of second movement objects in the first direction with the plurality of first movement objects and the plurality of second movement objects being arranged in a layer that is lower than a layer that the fixed object is in, and a second direction movement controller to move, in a case that the second direction operation detector detects an operation in the second direction, any one or more of the plurality of second movement objects in the second direction with the plurality of second movement objects being arranged in a layer that is lower than a layer that the plurality of first movement objects are in, and the plurality of first movement objects being fixed, the second movement objects(s) other than the any one or more of the plurality of second movement objects being fixed.

Other features of preferred embodiments of the present invention will be apparent from the description and illustrations in the specification and drawings.

According to preferred embodiments of the present invention, fixed objects are visible even when first and second movement objects overlap the fixed objects in response to an operation in a first direction. The first movement objects are visible even when the second movement objects overlap the first movement objects in response to an operation in a second direction.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram showing a configuration of a display control device.

FIG. 2 is a diagram showing an edit screen and an area outside it.

FIG. 3 is a diagram for use in explaining how the edit screen is divided.

FIG. 4 is a diagram for use in explaining that first and second movement objects move in the horizontal direction in response to a horizontal swipe or drag-and-drop operation.

FIG. 5 is a diagram for use in explaining that the second movement objects move in the vertical direction in response to a vertical swipe or drag-and-drop operation.

FIG. 6 is a diagram for use in explaining decision regions used to determine stop positions for the first and second movement objects that have moved in the horizontal direction.

FIG. 7 is a diagram for use in explaining that the first and second movement objects that have moved in the horizontal direction move to their stop positions and then stop.

FIG. 8 is a diagram for use in explaining decision regions used to determine stop positions for the second movement objects that have moved in the vertical direction.

FIG. 9 is a diagram for use in explaining that the second movement objects that have moved in the vertical direction move to their stop positions and then stop.

FIG. 10 is a diagram showing an edit screen and an area outside it.

### DETAILED DESCRIPTION OF THE PREFERRED EMBODIMENTS

Referring to the drawings, preferred embodiments of the present invention are described. The preferred embodiments described below, however, include various features that are technically preferable for the purpose of implementing the present invention. The scope of the present invention is not limited to the following preferred embodiments and illustrated examples.

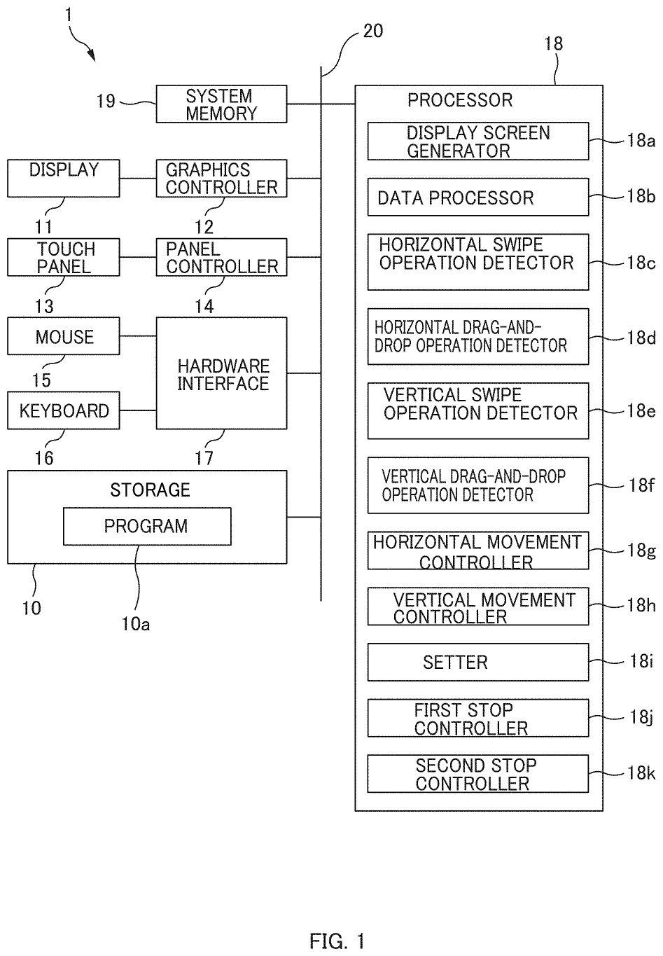

FIG. 1 is a block diagram of a display control device 1. The display control device 1 is a mobile information processing device such as a notebook computer system, a tablet computer system, or a smartphone.

The display control device 1 includes a storage 10, a display 11, a graphics controller 12, a touch panel 13, a panel controller 14, a mouse 15, a keyboard 16, a hardware interface 17, a processor 18, a system memory 19, a system bus 20 and so on.

The storage 10, the graphics controller 12, the panel controller 14, the hardware interface 17, the processor 18, and the system memory are connected to the system bus 20. The system bus 20 transfers data and signals among the storage 10, the graphics controller 12, the panel controller 14, the hardware interface 17, the processor 18, and the system memory 19.

The storage 10 is a storage medium including a semiconductor memory or a hard disk drive and other components, the content of which can be read and write by the processor 18. The storage 10 stores a program 10a that can be executed by the processor 18.

The display 11 is a thin display such as a liquid crystal display, an organic EL display, or an inorganic EL display. The display 11 is connected to the graphics controller 12.

The graphics controller 12 generates video signals according to the commands from the processor 18 and outputs these video signals to the display 11. In response to this, videos according to the video signals appear on the display 11.

The touch panel 13 is a transparent pointing device layered on the display surface of the display 11. The touch panel 13 is connected to the panel controller 14.

The panel controller 14 controls the touch panel 13 according to the commands from the processor 18. Based on the control of the panel controller 14 to the touch panel 13, the touch panel 13 detects the point of contact of a contacting object (such as a user's finger or stylus) on the touch panel 13 when the panel controller 14 generates a signal indicative of that point of contact and outputs the signal to the processor 18. Each point of contact is represented by its x- and y-coordinates on the surface of the touch panel 13 in which the x-coordinates locate the positions on a horizontal line (in the first direction) and the y-coordinates locate the positions on a vertical line (in the second direction) on the surface of the touch panel 13. The verticals and horizontals of the surface of the touch panel 13 are parallel to the verticals and horizontals of the screen on the display 11, respectively.

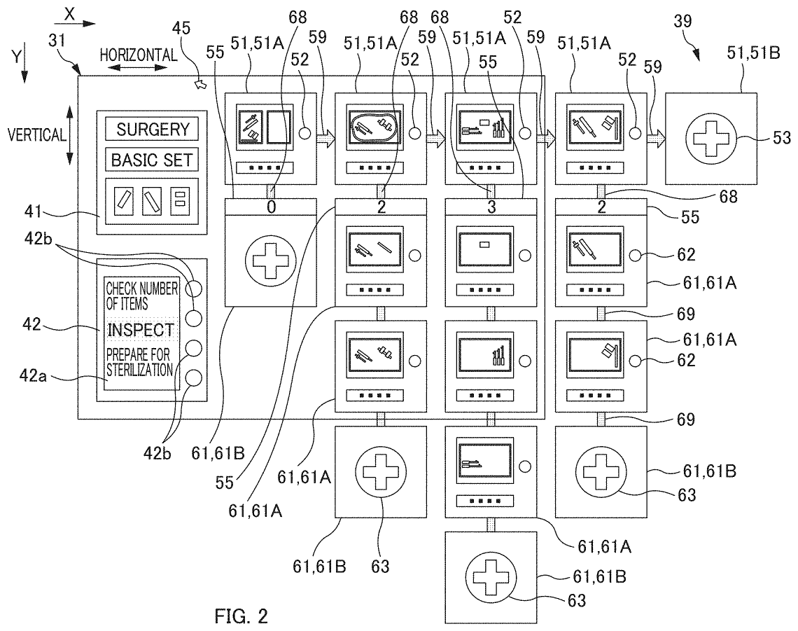

The mouse 15 is connected to the hardware interface 17. The mouse 15 is a pointing device used to move a pointer 45 (see FIG. 2) displayed on the display 11 and selecting and executing displayed objects (such as widgets, icons, and/or buttons) with the pointer 45. When a user performs a mouse click, the mouse 15 outputs a signal indicative of it to the hardware interface 17. Furthermore, when the user moves the mouse 15 around and manipulates it, the mouse 15 outputs a signal indicative of a vector in the direction of movement to the hardware interface 17. The vector in the direction of movement is represented by a horizontal displacement and a vertical displacement perpendicular to the horizontal. The processor 18 computes the position of the pointer 45 based on the signal (the vector in the direction of movement) received from the mouse 15 and presents a display screen on the display 11 with the pointer 45 located at that position. The position of the pointer 45 is represented by its x- and y-coordinates.

The keyboard 16 is connected to the hardware interface 17. The keyboard 16 outputs a signal corresponding to the key depressed by the user to the hardware interface 17.

The hardware interface 17 transfers signals between the processor and the mouse 15/the keyboard 16.

The system memory 19 includes a random-access memory (RAM). The system memory 19 provides a work area for the processor 18.

The processor 18 includes a central processing unit (CPU) and other components. The processor 18 reads a program 10a from the storage 10 and loads it into the system memory 19 to execute.

The program 10a assists users in creating contents (operation flow contents) to express a flow of a medical instrument handling operation in order to visually present, to an operator, details of the medical instrument handling operation related to handling of medical instruments.

The medical instrument handling operation is a series of procedures performed for surgeries in which medical instruments are used. The medical instrument handling operation includes upper-level processes. Each upper-level process includes intermediate-level processes. Each intermediate-level process includes lower-level processes. Users edit the order of the upper-, intermediate-, and lower-level processes and job details using the program 10a.

Medical instruments include instruments such as endoscopes, ultrasonic probes, pairs of forceps, pairs of scissors, scalpels, scalpel handles, cannulas, tweezers, retractors, scales, Sondes, elevators, raspas, suction tubes, rib spreaders, rib contractors, needle holders, syringes, metal balls, kidney dishes, cups, pins, mirrors, files, opening devices, Klemmes, handpieces, Elevatoriums, chisels, curettes, raspatories, mirrors, suture needles, rongeurs, water receivers, needles, spatulas, bougies, vent tubes, bone impactors, rongeurs, needle-nose pliers, hammers, goniometers, perforators, droppers, metal swabs, enemas, and syringes. Combinations of two or more instruments (such as surgical kits composed of pairs of forceps, scalpels, and pairs of scissors) are also included in the medical instruments.

When the program 10a is executed by the processor 18, the processor 18 functions as a display screen generator 18a, a data processor 18b, a horizontal swipe operation detector 18c, a horizontal drag-and-drop operation detector 18d, a vertical swipe operation detector 18e, a vertical drag-and-drop operation detector 18f, a horizontal movement controller 18g, a vertical movement controller 18h, a setter 18i, a first stop controller 18j, and the second stop controller 18k. Functions of these functional elements 18a to 18k along with display screens that appear on the display 11 are described in detail below.

The display screen generator 18a commands the graphics controller 12 to display an edit screen 30 (see FIG. 2) as a display screen on the display 11. This generates a graphical user interface (GUI). With the edit screen 30 being displayed on the display 11, a user's instruction with the touch panel 13, the mouse 15 or the keyboard 16 triggers the data processor 18b to generate data of an operation flow content according to the instruction. The data processor 18b then records the data on the storage and controls the denotation of the edit screen based on the instruction.

FIG. 2 shows an example of the edit screen 30 that is displayed on the display 11 by the display screen generator 18a and an area 39 outside it. The area 39 outside the edit screen 30 is processed and subjected to computation by the display screen generator 18a but does not appear on the display 11. Furthermore, an xy-coordinate system in which points of contact that are detected by the touch panel 13 are represented is the same as the coordinate system in which positions in the edit screen 30 are represented.

Fixed objects 41 and 42 are vertically arranged in a column with some spacing between them on the left side of the edit screen 30. Since the fixed objects 41 and 42 are arranged away from the edge of the edit screen 30 and the fixed objects 41 and 42 are arranged with some spacing between them, there are background areas (blank areas) around the fixed objects 41 and 42.

The fixed objects 41 and 42 are fixed on the edit screen 30. The fixed objects 41 and 42 cannot be moved even when the user operates the touch panel 13, the mouse 15 or the keyboard 16.

The fixed object 41 is a widget that displays information about medical instruments. For example, the fixed object 41 displays at least one of images of the medical instruments, their names, owners, departments, storage places, purposes of use, and where to use them. The information displayed in the fixed object 41 is specified by the display screen generator 18a retrieving it from operation flow content data in the storage 10. The operation flow content data is generated by the data processor 18b in response to the user's editing of the order of the upper-, intermediate-, and lower-level processes, and the job details using the program 10a. Widgets are the elements that make up a GUI.

The fixed object 42 includes a list box 42a and multiple buttons 42b arranged therein.

The list box 42a displays, as items (from which the user can select), names of the upper-level processes making up of the medical instrument handling operation in process order, starting from the top. Among the items in the list box 42a, the selected item gets highlighted and the items that are not selected appear with no highlight. The names of the upper-level processes displayed in the list box 42a are specified by the display screen generator 18a retrieving it from the operation flow content data in the storage 10.

The buttons 42b are used to delete a selected item, change the order of the processes, and add a new item.

Intermediate- and lower-level processes, which are the elements of the upper-level process of the item selected from the items in the list box 42a, are represented in the following manner as first movement objects 51 and second movement objects 61 which are aligned in an array to the right of the fixed objects 41 and 42.

The first movement objects 51 at the top row are aligned in a side by side manner at an equal distance. These first movement objects 51 are widgets representing the intermediate-level processes of the upper-level process of the item selected from the items in the list box 42a. This means that the intermediate-level processes represented by the first movement objects 51 are the elements of the upper-level process of the item selected from the items in the list box 42a.

The alignment order of the first movement objects 51 in the horizontal direction corresponds to the order of the intermediate-level processes. In other words, the first movement objects 51 are horizontally aligned from left to right according to the order of the intermediate-level processes.

Link objects 59 are arranged between the first movement objects 51 that are next to each other. The link objects 59 indicate that an intermediate-level process continues to a subsequent intermediate-level process.

Below the first movement objects 51, except for the one on the far right, the upper second movement objects 61 are arranged in the first place. These second movement objects 61 in the first place are also aligned in a side by side manner. Further, below the second movement objects 61 in the first place, the second movement objects 61 are arranged in the second and subsequent places which are vertically aligned at an equal or substantially equal distance (note that if a second movement object 61 in the first place is an unregistered widget 61B described later, that second movement object 61 in the first place is not followed by any other second movement object).

The second movement objects 61 are widgets representing the lower-level processes of the intermediate-level processes represented by the first movement objects 51 at the top row. This means that the lower-level processes represented by the second movement objects 61 are the elements of the intermediate-level processes represented by the first movement objects 51 that are arranged above these second movement objects 61.

The alignment order of the second movement objects 61 in the vertical direction corresponds to the order of the lower-level processes. In other words, the second movement objects 61 are vertically aligned from top to bottom according to the order of the lower-level processes.

A link object 68 and a number-of-processes display object 55 are arranged next to each other between each first movement object 51 and the second movement object 61 beneath. Each link object 68 indicates that the intermediate-level process represented by the first movement object 51 above that link object 68 includes the lower-level processes represented by the second movement object 61 below that link object 68. Each number-of-processes display object 55 displays the number of registered lower-level processes. In other words, each number-of-processes display object 55 displays the number of the second movement objects 61 (which are registered widgets 61A described later) beneath.

Link objects 69 are arranged between the second movement objects 61 that are above and below each other. The link objects 69 indicate that a lower-level process continues to a subsequent lower-level process.

The first and second movement objects 51 and 61 have the same vertical dimension and the same horizontal dimension. The first movement objects 51 that are horizontally arranged in a single row have their vertical centers in alignment with each other.

The second movement objects 61 that are horizontally arranged also have their vertical centers in alignment with each other. Each first movement object 51 and the second movement object(s) 61 beneath have their horizontal centers in alignment with each other.

The first movement objects 51, the number-of-processes display objects 55, and the link objects 59 and 68 are arranged in a layer that is lower than the one that the fixed objects 41 and 42 are in. The second movement objects 61 and the link objects 69 are arranged in a layer lower than the layer that the first movement objects 51, the number-of-processes display objects 55, and the link objects 59 and 68 are in. Even when the user operates the touch panel 13, the mouse 15 or the keyboard 16, the layered relation of the fixed objects 41 and 42, the movement objects 51 and 61, the number-of-processes display objects 55, and the link objects 59, 68, and 69 can be maintained.

When the selection of the item in the list box 42a is changed, the upper-level process is changed to another upper-level process. This results in a change in display of the area that is right to the fixed objects 41 and 42 to the intermediate- and lower-level processes that are the elements of the upper-level process after the change.

The types of the movement objects 51 and 61 are described.

The first movement objects 51 are classified into registered widgets 51A and an unregistered widget 51B. The unregistered widget 51B is the first movement object 51 on the far right of the first movement objects 51 that are horizontally aligned. The remaining first movement objects 51 are all registered widgets 51A.

Each registered widget 51A indicates that the information about the intermediate-level process that it represents has been registered to the operation flow content data in the storage 10 by the user. The registered widgets 51A display information about job details of the intermediate-level processes. The information that appears on the registered widgets 51A (information about the job details of the intermediate-level processes) are displayed as a graphic image or a text or both. The information that appears on the registered widgets 51A (information about the job details of the intermediate-level processes) is specified by the display screen generator 18a retrieving the operation flow content data in the storage 10.

Each registered widget 51A displays an edit button 52. When the user selects and presses the edit button 52 with the touch panel 13 or the mouse 15, an input screen appears, allowing the user to change the information about the intermediate-level process in this input screen.

The unregistered widget 51B indicates that the information about the intermediate-level process that it represents has not been registered to the operation flow content data in the storage 10. The unregistered widget 51B displays an edit button 53. When the user selects and presses the edit button 53 with the touch panel 13 or the mouse 15, an input screen appears, allowing the user to register the information about the intermediate-level process in this input screen. In response to the registration of that information by the user, the unregistered widget 51B turns into the registered widget 51A that displays the registered information and a new unregistered widget 51B is added to the right of it.

The second movement objects 61 are classified into registered widgets 61A and unregistered widgets 61B. The unregistered widgets 61B are the second movement objects 61 at the bottom of the second movement objects 61 that are vertically aligned. The remaining second movement objects 61 are all registered widgets 61A.

Each registered widget 61A indicates that the information about the lower-level process that it displays has been registered to the operation flow content data in the storage 10 by the user. The registered widgets 61A display information about job details of the lower-level processes. The information that appears on the registered widgets 61A (information about the job details of the lower-level processes) are displayed as a graphic image or a text or both. The information that appears on the registered widgets 61A (information about the job details of the lower-level processes) is specified by the display screen generator 18a retrieving the operation flow content data in the storage 10.

Each registered widget 61A displays an edit button 62. When the user selects and presses the edit button 62 with the touch panel 13 or the mouse 15, an input screen appears, allowing the user to change the information about the lower-level process in this input screen.

The unregistered widget 61B indicates that the information about the lower-level process that it displays has not been registered to the operation flow content data in the storage 10. The unregistered widget 61B displays an edit button 63. When the user selects and presses the edit button 63 with the touch panel 13 or the mouse 15, an input screen appears, allowing the user to register the information about the lower-level process in this input screen. In response to the registration of that information by the user, the unregistered widget 61B turns into the registered widget 61A that displays the registered information and a new unregistered widget 61B is added to the right of it.

The movement objects 51 and 61 can be moved by a swipe operation or a drag-and-drop operation of the user. Detections of the swipe and drag-and-drop operations are described below. Note that the state in which the movement objects 51 and 61 have not yet been moved, that is, the state in which the movement objects 51 and 61 are arranged as shown in FIG. 2 is hereinafter referred to as a stationary state.

Swipe operations refer to a series of operations performed by the user to bring a contacting object into contact with the touch panel 13 (the point of contact detected by the touch panel 13 at that time is referred to as a “swipe operation start point”), slide the contacting object across the touch panel 13 while holding it on the touch panel 13, and then lift it up from the touch panel 13. The swipe operations may include either a vertical swipe operation, where the amount of vertical displacement of the sliding of the contacting object from the swipe operation start point is larger than the amount of horizontal displacement, or a horizontal swipe operation, where the amount of horizontal displacement of the contacting object from the swipe operation start point is larger than the amount of vertical displacement. Note that flick operations (a series of operations in which the amount of time from when the contacting object comes into contact with the touch panel 13 to when it is separated from the touch panel 13 after sliding is short) are regarded as swipe operations.

Drag-and-drop operations refer to a series of operations performed by the user to press a button of the mouse 15 (the position of the pointer 45 at that time is referred to as a “drag-and-drop operation start point”), move the mouse 15 with the button being pressed, and then release the button of the mouse 15. The drag-and-drop operations may include either a vertical drag-and-drop operation or a horizontal drag-and-drop operation, where the amount of vertical displacement of the mouse 15 moving from the drag-and-drop operation start point is larger than the amount of horizontal displacement in the vertical drag-and-drop operation and the amount of horizontal displacement of the mouse 15 from the drag-and-drop operation start point is larger than the amount of vertical displacement in the horizontal drag-and-drop operation.

When the user performs a horizontal swipe operation, the horizontal swipe operation detector 18c detects the horizontal swipe operation according to the signals received from the panel controller 14. On the other hand, when the user performs a vertical swipe operation, the vertical swipe operation detector 18e detects the vertical swipe operation according to the signals received from the panel controller 14.

When the user performs a horizontal drag-and-drop operation, the horizontal drag-and-drop operation detector 18d detects the horizontal drag-and-drop operation according to the signals received from the mouse 15. On the other hand, when the user performs a vertical drag-and-drop operation, the vertical drag-and-drop operation detector 18f detects the vertical drag-and-drop operation according to the signals received from the mouse 15.

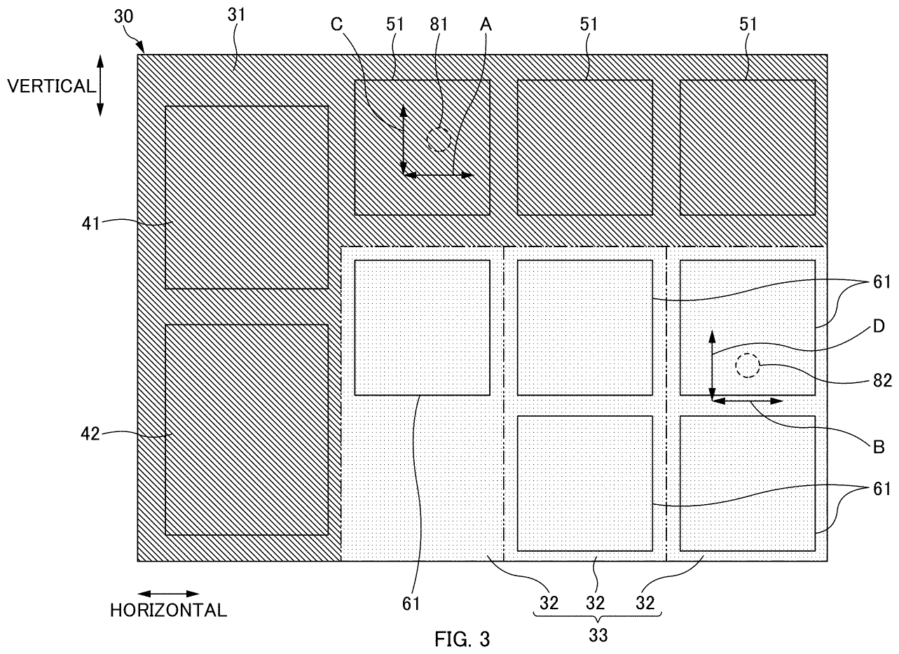

Here, since it is important to note the location of the swipe operation start point or the drag-and-drop operation start point in the edit screen 30 for moving the movement objects 51 and 61, the operation detectors 18c to 18f define a detection area 31 and three detection areas 32 in the edit screen 30 as shown in FIG. 3. With this, the edit screen 30 is divided into the detection area 31 and the three detection areas 32. The detection areas 31 and 32 in the edit screen 30 are now described. In FIG. 3, the detection area 31 is shown with oblique parallel lines and the detection areas 32 are shown with small dots to facilitate the understanding of the detection areas 31 and 32. Note that the detection areas 31 and 32 are not visually shown and not distinguishable on the edit screen 30.

The detection area 31 is L-shaped along the left and upper edges of the edit screen 30. The remaining rectangular or substantially rectangular area 33 is equally divided into three blocks horizontally. Thus, the rectangular or substantially rectangular three detection areas 32 each of which is longer in the vertical direction are aligned in a side by side manner. These three detection areas 32 have the same horizontal width and the same vertical length. The ranges for the detection area 31 and the three detection areas 32 are represented by providing x- and y-coordinates.

The portion of the detection area 31, which locates above the rectangular or substantially rectangular area 33, has room in which three first movement objects 51 can be horizontally aligned. The remaining portion of the detection area 31 has room in which the fixed objects 41 and 42 can be vertically aligned. As shown in FIG. 2, in the case of arranging the movement objects 51 and 61, three first movement objects 51 are horizontally aligned in the portion of the detection area 31 above the rectangular or substantially rectangular area 33.

Each of the detection areas 32 has room in which two second movement objects 61 can be vertically aligned. In the case of arranging the movement objects 51 and 61 as shown in FIG. 2, one second movement object 61 is arranged in the left detection area 32, two second movement objects 61 are vertically aligned in the central detection area 32, and two second movement objects 61 are vertically aligned in the right detection area 32. The second movement object 61 in the left area 32 has its horizontal center in alignment with the horizontal center of the left area 32. The second movement objects 61 that form the column including the second movement objects 61 in the central area 32 have their horizontal centers in alignment with the horizontal center of the central area 32. The second movement objects 61 that form the column including the second movement objects 61 in the right area 32 have their horizontal centers in alignment with the horizontal center of the right area 32.

With the movement objects 51 and 61 in the stationary state as shown in FIG. 2, when the user performs a horizontal swipe operation from a start point 81 in the detection area 31 as depicted by the arrow A in FIG. 3, the horizontal swipe operation detector 18c detects that. Then, the horizontal movement controller 18g moves all the movement objects 51 and 61, the number-of-processes display objects 55, and the link objects 59, 68, and 69 in the horizontal direction according to the signals (the x-coordinates of the point of contact) from the panel controller 14 until the horizontal swipe operation detector 18c ends the detection of the horizontal swipe operation.

The same applies to cases where the user performs a horizontal swipe operation from a start point 82 in the detection area 32 as depicted by the arrow B in FIG. 3. Accordingly, regardless of where the horizontal swipe operation start point locates in the edit screen 30, the horizontal movement controller 18g moves all the movement objects 51 and 61, the number-of-processes display objects 55, and the link objects 59, 68, and 69 in the horizontal direction.

With the movement objects 51 and 61 in the stationary state, when the user performs a horizontal drag-and-drop operation from the start point 81 in the detection area 31 as depicted by the arrow A in FIG. 3, the horizontal drag-and-drop operation detector 18d detects that. Then, the horizontal movement controller 18g moves all the movement objects 51 and 61, the number-of-processes display objects 55, and the link objects 59, 68, and 69 in the horizontal direction according to the signals from the mouse 15 until the horizontal drag-and-drop operation detector 18d ends the detection of the horizontal drag-and-drop operation.

The same applies to cases where the user performs a horizontal drag-and-drop operation from the start point 82 in the right area 32 as depicted by the arrow B in FIG. 3. Accordingly, regardless of where the horizontal drag-and-drop operation start point locates in the edit screen 30, the horizontal movement controller 18g moves all the movement objects 51 and 61, and the link objects 59, 68, and 69 in the horizontal direction.

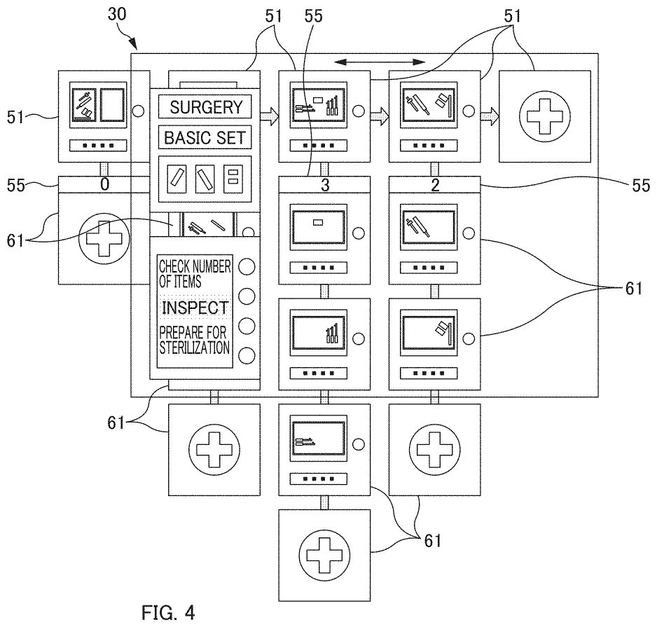

Referring to FIG. 4, how the movement objects 51 and 61 and the link objects 59, 68, and 69 are moved by the horizontal movement controller 18g is described. As shown in FIG. 4, all the movement objects 51 and 61, the number-of-processes display objects 55, and the link objects 59, 68, and 69 move in the horizontal direction with their arrangement kept unchanged (see the arrows in FIG. 4). Accordingly, the movement objects 51 and 61 that were arranged to the right of and outside the edit screen 30 before the horizontal swipe or drag-and-drop operation come to be displayed in the edit screen 30.

As described above, even when the user performs a horizontal swipe or drag-and-drop operation, the horizontal movement controller 18g keeps the state in which the fixed objects 41 and 42 are arranged in the layer that is higher than the one that the movement objects 51 and 61, the number-of-processes display objects 55, and the link objects 59, 68, and 69 are in. Therefore, as shown in FIG. 4, when a horizontal swipe or drag-and-drop operation moves the movement objects 51 and 61, the number-of-processes display objects 55, and the link objects 59, 68, and 69 across the fixed objects 41 and 42, the portions of the movement objects 51 and 61, the number-of-processes display objects 55, and the link objects 59, 68, and 69 that are overlapped with the fixed objects 41 and 42 are not displayed and the portions that are outside the outer periphery of each of the fixed objects 41 and 42 are displayed.

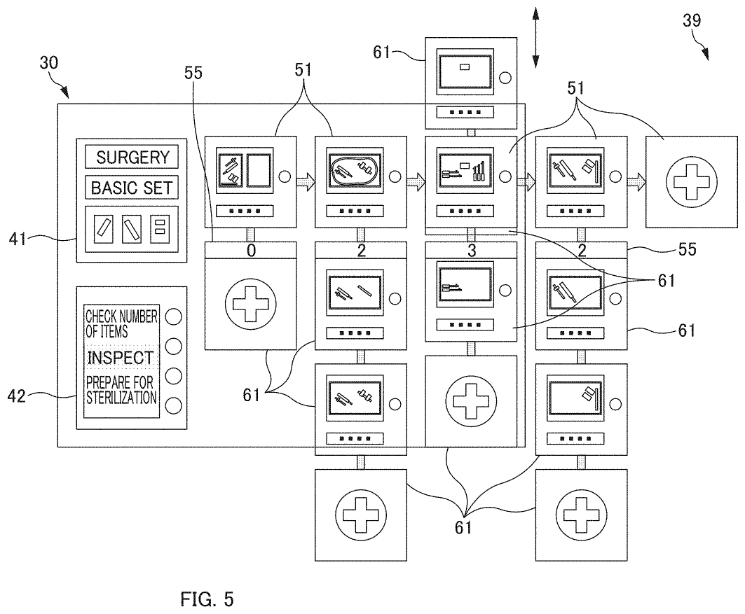

With the movement objects 51 and 61 in the stationary state, when the user performs a vertical swipe operation from the start point 82 in the right detection area 32 as depicted by the arrow D in FIG. 3, the vertical swipe operation detector 18e detects that. Then, the vertical movement controller 18h moves the second movement objects 61 and the link objects 69 in the vertical direction according to the signals (the y-coordinates of the point of contact) from the panel controller 14 while maintaining a positional relation of all the second movement objects 61 and the link objects 69 that form the column including the second movement objects 61 in the right detection area 32 as shown in FIG. 5, until the vertical swipe operation detector 18e ends the detection of the vertical swipe operation. In this case, the vertical movement controller 18h keeps the other movement objects 51 and 61, the number-of-processes display objects 55, and the link objects 59, 68, and 69 in a fixed state.

On the other hand, with the movement objects 51 and 61 in the stationary state, when the user performs a vertical drag-and-drop operation from the start point 82 in the right detection area as shown in the arrow D in FIG. 3, the vertical drag-and-drop operation detector 18f detects that. Then, as in the case of the vertical swipe operation, the vertical movement controller 18h moves, in the vertical direction, all the second movement objects and the link objects 69 that form the column including the second movement objects 61 in the right detection area 32 according to the signals (vertical displacement) from the mouse 15.

As described above, even when the user performs a vertical swipe or drag-and-drop operation, the vertical movement controller 18h keeps the state in which the first movement objects 51, the number-of-processes display objects 55, and the link objects 59 and 68 are arranged in the layer that is higher than the one that the second movement objects 61 and the link objects are in. Therefore, when a vertical swipe or drag-and-drop operation moves the second movement objects 61 and the link objects 69 across the first movement objects 51, the portion of the second movement objects 61 and the link objects 69 that is overlapped with the first movement object 51 is not displayed and the portion(s) that is/are outside the outer periphery of the first movement object 51 is/are displayed.

With the movement objects 51 and 61 in the stationary state, when the user performs a vertical swipe or drag-and-drop operation from a start point in the central detection area 32, all the second movement objects 61 and the link objects 69 that form the column including the second movement objects 61 in the central detection area 32 move in the vertical direction while maintaining their relative positional relation.

With the movement objects 51 and 61 in the stationary state, when the user performs a vertical swipe or drag-and-drop operation from a start point in the left detection area 32, all the second movement objects 61 and the link objects 69 that form the column including the second movement objects 61 in the left detection area 32 move in the vertical direction while maintaining their relative positional relation.

With the movement objects 51 and 61 in the stationary state, when the user performs a vertical swipe or drag-and-drop operation from the start point 81 in the detection area 31 as shown in the arrow C in FIG. 3, all the movement objects 51 and 61 are kept in a fixed state.

As described above, in response to a horizontal swipe or drag-and-drop operation, all the movement objects 51 and 61 move in the horizontal direction (see FIG. 4). At the end of the horizontal swipe or drag-and-drop operation, the movement objects 51 and 61 do not stop at the position where they are at the end; instead, they move from the position at the end to a certain position and then stop. This is described in detail below.

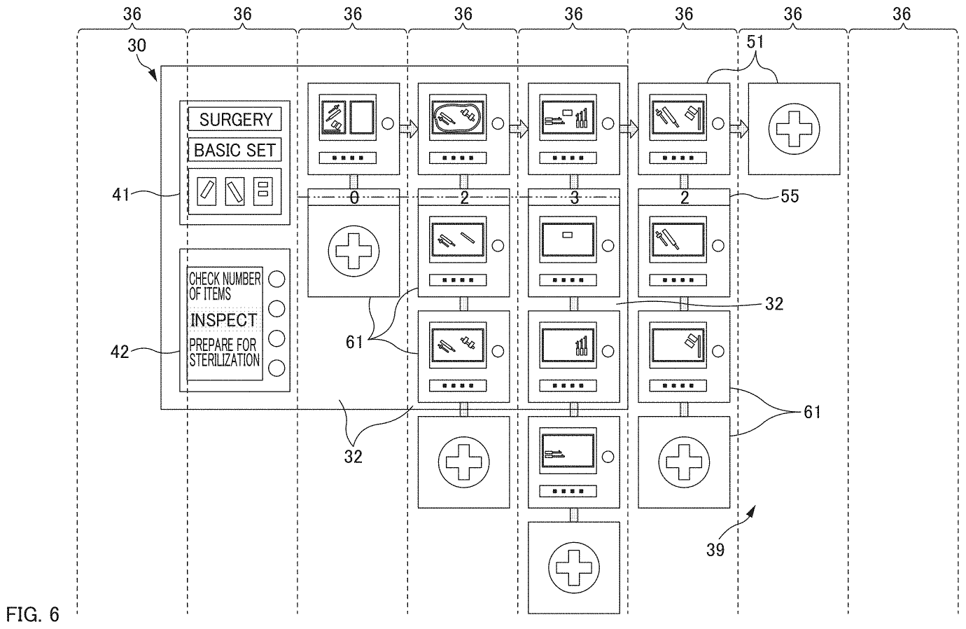

In order to determine where to stop the movement objects 51 and 61 at the end of each horizontal swipe or drag-and-drop operation, the setter 18i sets multiple decision regions 36 in the edit screen 30 and the area 39 outside it as shown in FIG. 6. Each decision region 36 has a strip shape which is longer in the vertical direction. The edit screen 30 and the area 39 outside it are horizontally divided and the decision regions 36 are aligned next to each other in the horizontal direction. The decision regions 36 have the same or substantially the same horizontal width. The horizontal width of the decision region 36 is equal or substantially equal to the horizontal width of the detection area 32. Furthermore, the right three decision regions 36 that are obtained by vertically dividing the edit screen 30 overlap the respective three detection areas 32, and vertical edges of the three decision regions 36 overlap the vertical edges of the detection areas 32. The range of the decision regions 36 is represented by the x-coordinates.

Furthermore, with the movement objects 51 and 61 in the stationary state as shown in FIG. 2 before a horizontal swipe or drag-and-drop operation, the first movement objects 51 and the second movement objects 61 beneath are vertically aligned in the decision regions 36. The movement objects 51 and 61 are arranged in such a manner that their horizontal centers are in alignment with the horizontal centers of the decision regions 36.

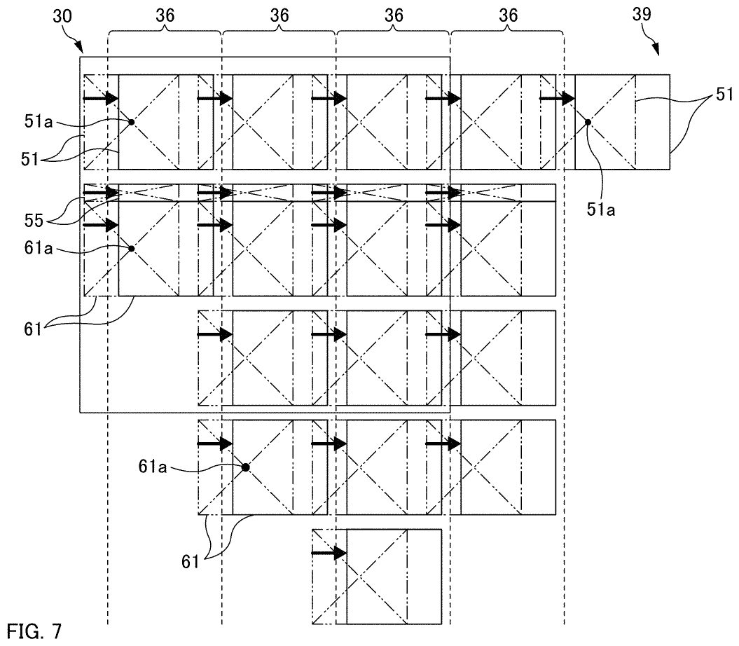

Referring to FIG. 7, a behavior of the movement objects 51 and 61 after the end of each horizontal swipe or drag-and-drop operation is described. In FIG. 7, the positions of the movement objects 51 and 61 at the end of the horizontal swipe or drag-and-drop operation are depicted by a long-dashed double-dotted line and the positions where the movement objects 51 and 61 stop are depicted by a solid line.

When the user stops performing his horizontal swipe operation, the horizontal swipe operation detector 18c stops detecting the horizontal swipe operation. When the user stops his horizontal drag-and-drop operation, the horizontal drag-and-drop operation detector 18d stops detecting the horizontal drag-and-drop operation.

When the horizontal swipe operation detector 18c or the horizontal drag-and-drop operation detector 18d stops its detection, the first stop controller 18j moves the movement objects 51 and 61 in the horizontal direction (see the arrows in FIG. 7) until the movement objects 51 and 61 are enclosed in the decision regions 36 where representative points 51a and 61a of the movement objects 51 and 61, respectively, are present as shown in FIG. 7, and then stops them. The movement objects 51 and 61 at the end have their horizontal centers in alignment with the horizontal centers of the decision regions 36 where the representative points 51a and 61a are present at the end of the horizontal swipe or drag-and-drop operation.

Although the representative points 51a and 61a are defined at the center of the respective movement objects 51 and 61, they may be defined any points other than the centers as long as they are inside the outer peripheries of the movement objects and 61. With the representative points 51a and 61a being defined on the respective vertical centers of the movement objects 51 and 61, when the distance moved by the movement objects 51 and in the left direction from the beginning to the end of a horizontal swipe or drag-and-drop operation is equal to or larger than about 50% but smaller than about 150% of the horizontal width of the decision region 36, the movement objects 51 and 61 stop in the decision regions 36 that are on the left of the decision regions 36 where they were at the beginning of the movement with their horizontal centers in alignment with the horizontal centers of those left decision regions 36. When the distance moved by the movement objects 51 and 61 in the left direction from the beginning to the end of a horizontal swipe or drag-and-drop operation is equal to or larger than 0% but smaller than about 50% of the horizontal width of the decision region 36, the movement objects 51 and 61 stop in the decision regions 36 where they were at the beginning of the movement with their horizontal centers in alignment with the horizontal centers of those decision regions 36.

All the movement objects 51 and 61, the number-of-processes display objects 55, and the link objects 59, 68, and 69 maintain their relative arrangement and alignment until the movement objects 51 and 61 have moved from the position at the end of the horizontal swipe or drag-and-drop operation to their stop positions.

As described above, in response to a vertical swipe or drag-and-drop operation, all the movement objects 61 that form any one of columns move in the vertical direction and other movement objects 51 and 61 are left fixed (see FIG. 5). At the end of the horizontal swipe or drag-and-drop operation, the second movement objects 61 that have moved do not stop at the position where they are at the end; instead, they move from the position at the end to a certain position and then stop. This is described in detail below.

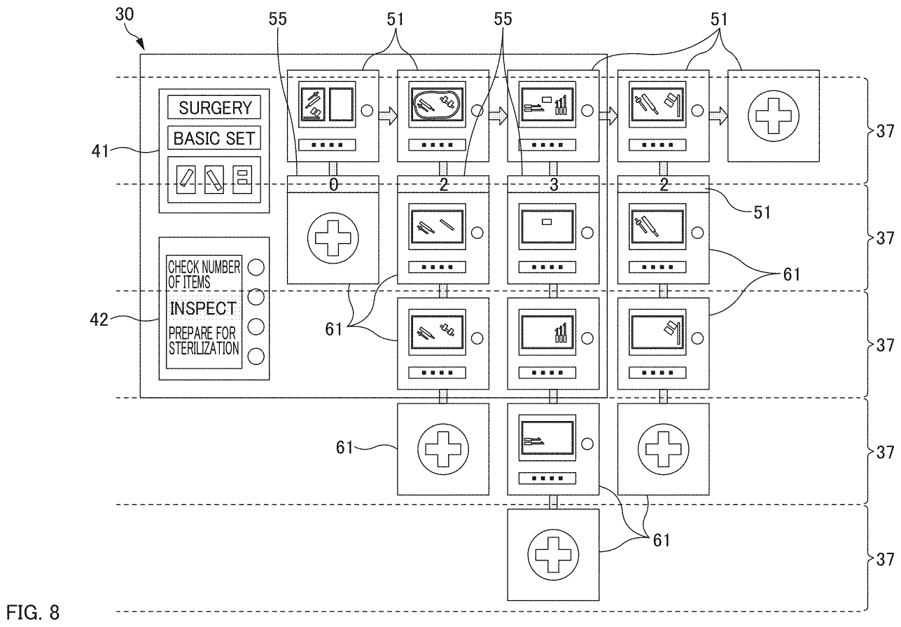

In order to determine where to stop the second movement objects 61 at the end of each vertical swipe or drag-and-drop operation, the setter 18i sets multiple decision regions 37 in the edit screen 30 and the area 39 outside it as shown in FIG. 8. Each decision region 37 has a strip shape which is longer in the horizontal direction. The edit screen 30 and the area 39 outside it are vertically divided and the decision regions 37 are aligned next to each other in the vertical direction. The decision regions 37 have the same vertical width. The range of the decision regions 37 is represented by the y-coordinates.

Furthermore, with the movement objects 51 and 61 in the stationary state as shown in FIG. 2 before a vertical swipe or drag-and-drop operation, the second movement objects 61 are horizontally aligned in the decision regions 37. The second movement objects 61 are arranged in such a manner that their vertical centers are in alignment with the vertical centers of the decision regions 37.

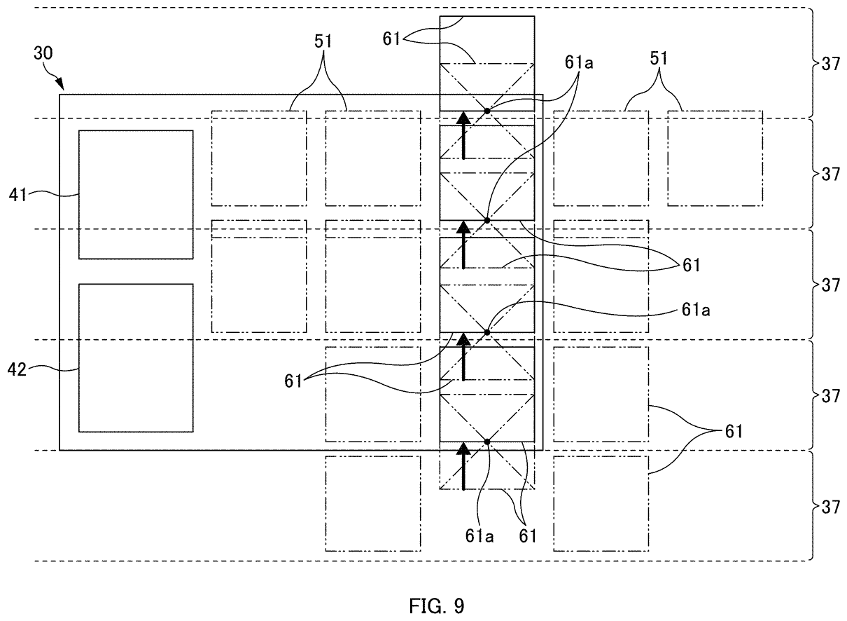

Referring to FIG. 9, a behavior of the second movement objects 61 after the end of each vertical swipe or drag-and-drop operation is described. In FIG. 9, the positions of the second movement objects 61 at the end of the vertical swipe or drag-and-drop operation (the second movement objects 61 that have moved in response to the vertical swipe or drag-and-drop operation) are depicted by a long-dashed double-dotted line and the positions where the second movement objects 61 stop are depicted by a solid line. The movement objects 51 and 61 that do not move during the vertical swipe or drag-and-drop operation is depicted by a long dashed dotted line.

When the user stops performing his vertical swipe operation, the vertical swipe operation detector 18e stops detecting the vertical swipe operation. When the user stops his vertical drag-and-drop operation, the vertical drag-and-drop operation detector 18f stops detecting the vertical drag-and-drop operation.

When the vertical swipe operation detector 18e or the vertical drag-and-drop operation detector 18f stops its detection, the second stop controller 18k moves the second movement objects 61 that have moved in response to the vertical swipe or drag-and-drop operation in the vertical direction (see the arrows in FIG. 9) until these second movement objects 61 are enclosed in the decision regions 37 where representative points 61a of these second movement objects 61 are present as shown in FIG. 9, and then stops them. The second movement objects 61 at the end have their vertical centers in alignment with the vertical centers of the decision regions 37 where the representative points 61a are present at the end of the vertical swipe or drag-and-drop operation.

With the representative points 61a being defined on the respective vertical centers of the second movement objects 61, when the distance moved by the second movement objects 61 upward from the beginning to the end of a vertical swipe or drag-and-drop operation is equal to or larger than about 50% but smaller than about 150% of the vertical width of the decision region 37, the second movement objects 61 stop in the decision regions 37 that are immediately above the decision regions 37 where they were at the beginning of the movement with their vertical centers in alignment with the vertical centers of those upper decision regions 37. When the distance moved by the second movement objects 61 upward from the beginning to the end of a vertical swipe or drag-and-drop operation is equal to or larger than 0% but smaller than about 50% of the horizontal width of the decision region 37, the second movement objects 61 stop in the decision regions 37 where they were at the beginning of the movement with their vertical centers in alignment with widthwise centers of those decision regions 37.

Since the fixed objects 41 and 42 are arranged in a layer that is higher than the one that the movement objects 51 and 61, the number-of-processes display objects 55, and the link objects 59, 68, and 69 are in, when the movement objects 51 and 61, the number-of-processes display objects 55, and the link objects 59, 68, and 69 overlap the fixed objects 41 and 42 in response to a horizontal swipe operation or drag-and-drop operation, the fixed objects 41 and 42 as well as the information that they display can be seen.

Since the first movement objects 51 and the number-of-processes display objects 55 are arranged in a layer that is higher than the one that the second movement objects 61 and the link objects 69 are in, when the second movement objects 61 and the link objects 69 overlap the first movement objects 61 and the number-of-processes display objects 55 in response to a vertical swipe operation or drag-and-drop operation, the first movement objects 61 and the number-of-processes display objects 55 as well as the information that they display can be seen.

All the movement objects 51 and 61 moves in the horizontal direction in response to a horizontal swipe or drag-and-drop operation and the movement objects 51 and 61 that overlap the fixed objects 41 and 42 are hidden by the fixed objects 41 and 42. Using such a behavior, it is possible to represent that the information displayed in the movement objects 51 and 61 is associated with or belongs to the information that the fixed objects 41 and 42 display.

In response to a vertical swipe or drag-and-drop operation, the second movement objects 61 that are arranged below any one of first movement object 51 move in the vertical direction and the second movement object(s) 61 that is/are overlapped with the first movement object 51 is/are hidden by the first movement object 51. Other second movement objects 61 do not move. Using such a behavior, it is possible to represent that the information displayed in the moving second movement objects 61 is associated with or belongs to the information that the first movement object 51 on the same column display.

After the end of a horizontal swipe or drag-and-drop operation, the movement objects 51 and 61 moves in the horizontal direction until they are enclosed in the decision regions 36 (see the arrows in FIG. 7). Therefore, with no swipe or drag-and-drop operation, the movement objects 51 and 61 always stay at their determined positions (in certain decision regions 36).

After the end of a vertical swipe or drag-and-drop operation, the second movement objects 61 that have moved in the vertical direction move until they are enclosed in the decision regions 37 (see the arrows in FIG. 9). Therefore, with no swipe or drag-and-drop operation, the second movement objects 61 always stay at their determined positions (in certain decision regions 37).

The movement objects 51 and 61, and the number-of-processes display objects 55 that are arranged on a horizontal outside of the edit screen 30 before a horizontal swipe or drag-and-drop operation are displayed in the edit screen in response to a horizontal swipe or drag-and-drop operation. Therefore, these objects 51, 61, and 55 as well as the information that they display can be seen.

The second movement objects 61 that are arranged on a vertical outside of the edit screen 30 before a vertical swipe or drag-and-drop operation are displayed in the edit screen 30 in response to a vertical swipe or drag-and-drop operation. Therefore, the second movement objects 61 as well as the information that they display can be seen.

Since the fixed object 41 and the fixed object 42 are separated from each other, the second movement objects 61 and the number-of-processes display objects 55 can be seen when the second movement objects 61 and the number-of-processes display objects 55 overlap the fixed objects 41 and 42 in response to a horizontal swipe or drag-and-drop operation.

Although preferred embodiments of the present invention have been described above, the preferred embodiments are described for the purpose of facilitating the understanding of the present invention and are not intended to limit the interpretation of the present invention. Further, the preferred embodiments of the present invention can be changed and improved without departing from the spirit thereof and the present invention includes equivalents thereof. Hereinafter, changes from the above-mentioned preferred embodiments are described. These changes described below can be applied in combination.

The objects 41, 42, 51, and 61 are widgets in the above-mentioned preferred embodiments; instead, the objects 41, 42, 51, and 61 may be icons or thumbnails.

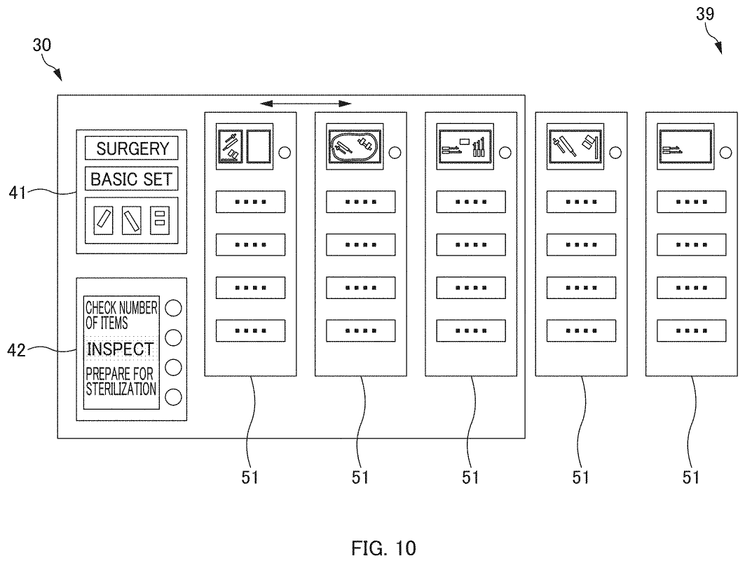

The second movement objects 61 and the link objects 59, 68, and 69 are arranged in the edit screen 30 and the area 39 outside it that the display screen generator 18a causes the display 11 to display in the above-mentioned preferred embodiments. The second movement objects, however, may not be arranged in the edit screen 30 and the area 39 outside it as shown in FIG. 10. In this case, the first movement objects 51 do not move when the user performs a vertical swipe or drag-and-drop operation.

In addition, when the user performs a horizontal swipe operation, this is detected by the horizontal swipe operation detector 18c. When the user performs a horizontal swipe operation, this is detected by the horizontal drag-and-drop operation detector 18d. Then, the horizontal movement controller 18g moves all the movement objects 51 in the horizontal direction according to the signals (the x-coordinates of the point of contact) from the panel controller 14 until the horizontal swipe operation detector 18c or the horizontal drag-and-drop operation detector 18d ends their detection. In this case, the layered relation of the fixed objects 41 and 42, the movement objects 51 is maintained and the relative positional relation of the movement objects 51 is also maintained.

When the horizontal swipe operation detector 18c or the horizontal drag-and-drop operation detector 18d ends their detection, the first stop controller 18j moves the movement objects 51 in the horizontal direction until these movement objects 51 are enclosed in the decision regions 36 in which the representative points (central points) of the respective movement objects 51 are present (see FIG. 6), and then stops them.

In the above-mentioned preferred embodiments, the “operation in the first direction” is the “horizontal swipe operation” or the “horizontal drag-and-drop operation” and the “operation in the second direction” is the “vertical swipe operation” or the “vertical drag-and-drop operation”; however, the “operation in the first direction” may be the “vertical swipe operation” or the “vertical drag-and-drop operation” and the “operation in the second direction” may be the “horizontal swipe operation” or the “horizontal drag-and-drop operation.” In this case, the terms “vertical direction,” “horizontal direction,” “upward,” “above,” “below,” “on the left,” and “on the right” in the description of the above-mentioned preferred embodiments should read “horizontal direction,” “vertical direction,” “to the left,” “on the left,” “on the right,” “above,” and “below,” respectively.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-4. (canceled)

5. A non-transitory computer-readable medium including a program for moving objects, the program causing a computer to function as:
a first direction operation detector to detect an operation in a first direction in a first state in which:
a plurality of first movement objects and a plurality of second movement objects are aligned in the first direction on a first-direction side of a fixed object that is fixed in a display screen; and
the plurality of second movement objects are aligned on a second-direction side of each of the plurality of first movement objects, the second-direction side being perpendicular in the first direction;
a second direction operation detector to detect an operation in the second direction in the first state;
a first direction movement controller to move, in a case that the first direction operation detector detects an operation in the first direction, the plurality of first movement objects and the plurality of second movement objects in the first direction with the plurality of first movement objects and the plurality of second movement objects being arranged in a layer that is lower than a layer that the fixed object is in; and
a second direction movement controller to move, in a case that the second direction operation detector detects an operation in the second direction, any one or more of the plurality of second movement objects in the second direction with:
the plurality of second movement objects being arranged in a layer that is lower than a layer that the plurality of first movement objects are in;
the plurality of first movement objects being fixed; and
the second movement objects(s) other than the any one or more of the plurality of second movement objects being fixed.

6. The non-transitory computer-readable medium according to claim 5 causing the computer to function as:
a setter to set a plurality of decision regions such that the first movement objects and the second movement objects in the first state are enclosed in the decision regions, each of the decision regions having a strip shape and being longer in the second direction, the decision regions being adjacent to each other in the first direction; and
a stop controller to move, in a case that the first direction operation detector ends the detection of the operation in the first direction, the first movement objects and the second movement objects in the first direction such that the first movement objects and the second movement objects are enclosed in the decision regions in which representative points of the first movement objects and the second movement objects are present at a time of ending the detection, and then stopping the first movement objects and the second movement objects.

7. The non-transitory computer-readable medium according to claim 5 causing the computer to function as:
a setter to set a plurality of decision regions such that the first movement objects and the second movement objects in the first state are enclosed in the decision regions, each of the decision regions having a strip shape and being longer in the first direction, the decision regions being arranged in the second direction with being adjacent to each other; and
a stop controller to move, in a case that the second direction operation detector ends the detection of the operation in the second direction, the second movement objects that have been moved by the second direction movement controller such that the second movement objects that have been moved by the second direction movement controller are enclosed in the decision regions in which representative points of the second movement objects that have been moved by the second direction movement controller are present at a time of ending the detection, and then stopping the second movement objects that have been moved by the second direction movement controller.

8. A non-transitory computer-readable medium including a program for moving objects, the program causing a computer to function as:
a first direction operation detector to detect an operation in a first direction in a first state in which:
a first movement object is arranged in the first direction on a first-direction side of a fixed object that is fixed in a display screen; and
a second movement object is arranged on a second-direction side of the first movement object, the second-direction side being perpendicular in the first direction;
a second direction operation detector to detect an operation in the second direction in the first state;
a first direction movement controller to move, in a case that the first direction operation detector detects an operation in the first direction, the first movement object and the second movement object in the first direction with the first movement object and the second movement object being arranged in a layer that is lower than a layer that the fixed object is in; and
a second direction movement controller to move, in a case that the second direction operation detector detects an operation in the second direction, the second movement object in the second direction with:
the second movement object being arranged in a layer that is lower than a layer that the first movement object is in; and
the first movement object being fixed.
